(19) United States
(12) Patent Application Publication
(10) Pub. No.: US 2013/0309626 A1
(43) Pub. Date: Nov. 21, 2013

(54) METHOD FOR DESIGN OF CUSTOM COMPOSITE ORTHODONTIC WIRES AND IMPLEMENTATION THEREOF

(71) Applicants: Bindusaran Arunachalam Perumal Athithan, Tradehub 21 (SG); Mervyn Fathianathan, Tradehub 21 (SG); Renuga Gopal, Tradehub 21 (SG)

(72) Inventors: Bindusaran Arunachalam Perumal Athithan, Tradehub 21 (SG); Mervyn Fathianathan, Tradehub 21 (SG); Renuga Gopal, Tradehub 21 (SG)

(73) Assignee: BIOMERS PTE LTD, Tradehub 21 (SG)

(21) Appl. No.: 13/983,182

(22) PCT Filed: Feb. 9, 2011
(86) PCT No.: PCT/SG2011/000056

§ 371 Date: Aug. 1, 2013

(51) Int. Cl. A61C 7/00; A61C 7/28

(52) U.S. Cl. CPC A61C 7/002; A61C 7/28
USPC 433/24

(57) ABSTRACT

A method for design of a series of custom composite orthodontic wires comprises collecting data about an initial teeth configuration of a patient and generating a tooth movement plan. The tooth movement plan comprises determining both a bracket mounting location for each bracket on a corresponding tooth and a number of stages, including an initial stage, determining movement of teeth from the initial teeth configuration to a final teeth configuration, and determining the custom composite orthodontic wire for each stage of the number of stages. The custom composite orthodontic wire used at the initial stage has at least one multidimensional bend. The custom composite orthodontic appliance for moving teeth is implemented by attaching brackets at the bracket mounting location for each bracket on a corresponding tooth, and connecting the brackets with the custom composite archwire.

### FIELD OF THE INVENTION

This invention relates to a method for designing a series of custom orthodontic wires for orthodontic treatment of a patient and implementation thereof, and more particularly to a method for designing a series of custom composite orthodontic wires and implementation thereof.

### BACKGROUND OF THE INVENTION

Orthodontic devices are used to correct the position of the teeth of a patient. In one of most common types of orthodontic device, brackets are bonded to a patient's teeth and coupled together using an archwire. The combination of the brackets and the archwire generate a force on the teeth, causing the teeth to move. Once the teeth have moved to a desired position and are held in place for a certain period of time, the body adapts bone and tissue to maintain the teeth in the desired position.

Materials used for archwires have traditionally comprised stainless steel, cobalt chromium, titanium and their respective alloys. A major innovation has been the introduction of Nickel Titanium (NiTi) wires that brought about a change in treatment philosophy moving orthodontics from edgewise bracket systems to a straight wire technique. NiTi wires allow for continuous light force to be applied to teeth irrespective of the deflection necessary to engage with maloccluded teeth, gradually realigning the teeth to the desired position. Light force orthodontic treatment is considered to be beneficial to long term health of teeth as it reduces root resorption. However, all metal orthodontic devices have the disadvantage of being aesthetically unattractive.

Another major development in the field of orthodontics is the shift toward aesthetic orthodontic appliances. One such example is lingual braces. Lingual braces are made of metal brackets and metal wires, and while not truly aesthetic they are hidden from view by being only on the lingual side of the teeth. Although lingual braces may be used for mild to severe cases, generally they are not preferred. This is due in part because lingual appliances may interfere with the tongue and are considered to be inconvenient to the patient. Further, lingual braces also have limited working space for the orthodontist. For at least these reasons, labial braces (on the front of the teeth) are still preferred.

With lingual braces, because of the restricted working space and the unsuitability of the standard archwires, the archwires are typically customized to the patient's teeth configuration and desired movement chairside. Lingualcare Inc., produces lingual braces with custom metal wires for patients based on the initial teeth configuration and makes the wires such that they are parallel to the tooth surface in the bracket slot. The wires initially apply force on teeth, but become passive at the end of the treatment stage. This is a proactive method of customization but limited to simple rules of being parallel to the tooth surface and becoming inactive when the treatment stage end is reached. So in case of discrepancies, the orthodontist adjusts the lingual archwire to his/her preferred shape to modify the treatment.

Another aesthetic orthodontic appliance is a clear tray based appliance made from polymeric materials. For example, the Invisalign system is a series of customized trays based on a treatment breakdown which involves breaking the treatment into multiple steps of movement of 0.2 mm per tooth per tray, assuming a collision free movement of teeth. Individual trays of unique shape are custom designed for the patient from start to finish of the treatment. Movement of the teeth in response to the trays is different from archwires While using trays for teeth movement, most of the misaligned teeth are retained in the same position during the stage to serve as anchors while some of the teeth positions are being corrected. This results in a tooth movement plan that is somewhat limited. Thus the tray based system is inefficient when compared with a bracket and archwire system.

Suresmile provides a custom orthodontic solution which allows for treatment planning and metal archwire customization. It allows the orthodontist to input patient related data and plan treatment on a software program. Based on the placement of the brackets on the patient's teeth, Suresmile provides custom bent metal archwires only for finishing stages of orthodontic treatment. This reduces the chair time for the orthodontist in making minute bends to produce a perfect finish for the patient. These bends are necessary because of the inaccurate placement of brackets during bonding and are not a treatment necessity. Typically an initial stage uses a straight archwire with no bends, relying on the properties of the metal to be sufficient to handle high stress locations. A perfectly aligned arch should ideally be able to accept a smooth preformed archwire with no bends placed in it if the brackets are placed accurately at the onset of treatment. Thus, the motivation behind placing the bend is not for meeting a treatment objective of moving teeth, but rather to hold the teeth in a particular finished position without having the need to replace the brackets placed incorrectly.

Insignia is another custom solution that determines and produces custom brackets and custom arch forms for the patient from start to finish. This involves straightwire technique and no bend placed on the archwire by the solution provider. An arch form that is most suitable for the patient is designed out of the various wire sizes and materials that will be needed throughout the course of treatment instead of relying on the standard commercial archforms like the ideal, natural, broad archforms etc Unlike Suresmile which customizes wires for the final stages of treatment due to bracket placement errors or bracket leveling errors of commercial brackets, Insignia also designs custom brackets and bracket placement guides that remove the limitations and errors of standard brackets available commercially.

Other aesthetic orthodontic components include brackets made of ceramic or composite material including Inspire ICE from Ormco and Clarity from 3M Unitek. The Applicant of the present invention sells BioMers Translucent archwires made out of polymer composite which are the only truly aesthetic and also the only non-metallic archwires in the market. Polymer composites are not as pliable as conventional metal wires. Hence, presently available options for aesthetic labial orthodontic treatment solutions have been limited to mild and moderate cases Preformed polymer composite archwires have limited elastic deflection limits that make it difficult to engage brackets in teeth which are severely deflected without fracturing the archwire. Composite archwires also exert higher force levels as the amount of deflection increases. This results in high forces being applied on teeth that are heavily deflected. This is undesirable as it can lead to root resorption and patient discomfort. A major limitation of polymer composite wires is that the shape of polymer composite materials cannot be changed once formed. This means that the wire cannot be bent or shaped by the clinician to fit the required patient's arch or to control force exerted on teeth. With the use of NiTi wires low forces can be applied irrespective of the magnitude of deflection of the wire. A straight wire with no restrictive bends provides unlimited movement of teeth towards the final desired teeth configuration. This reduces the necessity to change wires frequently in order to move teeth to the desired configuration. Hence, an orthodontist has no motivation to stage treatment by placing bends that restrict tooth movement. During the final stages of treatment, an orthodontist is able to make permanent bends on metal wires manually depending on the patients current tooth position. Such adjustments are not possible for archwires made from polymer composite material. It would therefore be desirable to have an aesthetic archwire that is applicable for cases of all severities for use together with the reliably proven aesthetic brackets.

There is currently no non-metallic, aesthetic orthodontic wire in the market that can be used for comprehensive orthodontic treatment to cover all conditions ranging from mild to complex cases. Composite archwires do not possess the elastic range of NiTi and other flexible metal archwires. Also, no bends can be made by the orthodontist at chairside because the wires are not bendable in the cured form that they are supplied. It would be desirable to provide a method for the design of a series of custom composite orthodontic wires for comprehensive orthodontic treatment to cover all conditions ranging from mild to complex cases which provides light, continuous force for tooth movement.

### SUMMARY OF THE INVENTION

In accordance with a first aspect, a method for design of a series of custom orthodontic wires comprises collecting data about an initial teeth configuration of a patient and generating a tooth movement plan. The tooth movement plan comprises determining both a bracket mounting location for each bracket on a corresponding tooth and a number of stages, including an initial stage, determining movement of teeth from the initial teeth configuration to a final teeth configuration, and determining a custom composite archwire for each stage of the number of stages. The custom composite archwire used at the initial stage has at least one multidimensional bend. The custom orthodontic appliance for moving teeth is implemented by attaching brackets at the precise bracket mounting location for each bracket on a corresponding tooth by means of indirect bonding of brackets, and connecting the brackets with a custom composite archwire.

From the foregoing disclosure and the following more detailed description of various embodiments it will be apparent to those skilled in the art that the present invention provides a significant advance in the technology of custom orthodontic wires. Particularly significant in this regard is the potential the invention affords for providing a method for design of custom orthodontic wires and implementation thereof suitable for use with aesthetic orthodontic devices. Additional features and advantages of various embodiments will be better understood in view of the detailed description provided below.

### BRIEF DESCRIPTION OF THE DRAWINGS

FIG. 1 is a flow chart showing the steps of a method for design of a series of custom orthodontic wires and implementation thereof in accordance with one embodiment.

FIG. 2 is a schematic showing a tooth movement plan divided into a series of stages by use of tables.

FIG. 3 shows example tables suitable for an initial stage of a tooth movement plan.

FIG. 4 shows another example table, this table suitable for a stage prior to a final stage with distances measured from the final stage.

FIG. 5 is a graph comparing working force with several types of composite wires which can be used with the method disclosed herein.

It should be understood that the appended drawings are not necessarily to scale, presenting a somewhat simplified representation of various features illustrative of the basic principles of the invention. The specific design features of the composite orthodontic wires as disclosed here, including, for example, the specific dimensions of the archwire will be determined in part by the particular intended application and use environment. Certain features of the illustrated embodiments have been enlarged or distorted relative to others to help provide clear understanding. In particular, thin features may be thickened, for example, for clarity of illustration. All references to direction and position, unless otherwise indicated, refer to the orientation illustrated in the drawings.

### DETAILED DESCRIPTION OF CERTAIN EMBODIMENTS

It will be apparent to those skilled in the art, that is, to those who have knowledge or experience in this area of technology, that many uses and design variations are possible for the method of designing a series of custom orthodontic wires disclosed here. The following detailed discussion of various alternate features and embodiments will illustrate the general principles of the invention with reference to a custom orthodontic wire suitable for use with aesthetic brackets. Other embodiments suitable for other applications will be apparent to those skilled in the art given the benefit of this disclosure.

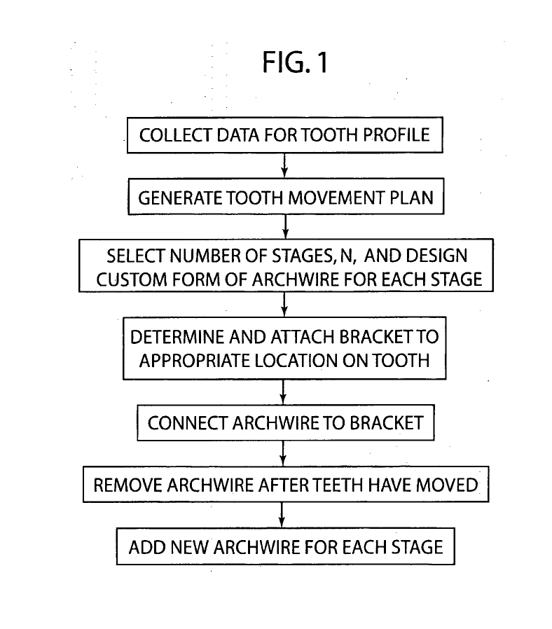

Turning now to the drawings, FIG. 1 shows a method for design of a series of custom composite orthodontic wires suitable for mild to complex cases. Composite materials, as used herein, refer to a combination of at least one ceramic reinforcement and one polymer/ceramic-polymer blend matrix. Optionally the archwire may be translucent, or may be coloured. Orthodontic appliances are used to adjust the position of teeth, and typically comprise brackets bonded or otherwise attached to teeth and an archwire connecting the brackets. The force required for correcting the tooth position is delivered by the archwires and transmitted to the tooth through the brackets. Hence, archwires are the active component of the orthodontic appliance and form the backbone of treatment by determining the force applied on individual teeth. The brackets are mounted at a bracket mounting location on each corresponding tooth. In addition to a position, the bracket mounting location may be mounted at a preselected angle on the corresponding tooth. This position is determined by the intersection of a vertical axis of the tooth with respect to the mouth as well as horizontal lines drawn at predetermined heights on a crown of the tooth. Typically one archwire is used on a top row of teeth and a second archwire can be used on a bottom row of teeth, with each archwire routed through bracket slots of a plurality of brackets.

The archwire is preferably releasably captivated in the bracket slots in such manner as to avoid sharp angular bends at the bracket edges which can result in high friction areas and cause stress concentrations, impeding treatment. Also, unlike the customized archwire shape used in lingual archwires, the archwires inside the bracket slot are not necessarily parallel to the tooth surface. Curved segments of wire in the bracket slot are regularly used especially for adjustment and to bring about controlled extrusion of teeth by application of force on one bracket edge selectively or on both bracket edges based on the manner in which curved segment is designed. Curved segment of the wire with partial ligation on one wing of a selected bracket is used in rotation of tooth based on whether the tooth is rotated in the mesial or distal direction.

As a first step in the method, data is collected for an initial teeth configuration of a patient. This can be done by an orthodontist making a mould of a patient's teeth, for example, or otherwise using 3D digital scanning, generating data corresponding to the initial configuration of the teeth that will be moved by use of the custom orthodontic wire. The data can further comprise malocclusion classification, bite analysis, arch length analysis, occlusion analysis and midline shifting information, for example.

The next step is generation of a tooth movement plan, where the plan is generated for movement of the teeth of the patient from the initial teeth configuration to a final teeth configuration. To help generate the tooth movement plan, the orthodontist may provide input on a choice of brackets, tooth movement order preference and space creation. The tooth movement plan includes determining a bracket mounting location for each bracket to be mounted on a tooth. Brackets typically are also attached at a bracket mounting angle with respect to a reference point.

In accordance with a highly advantageous feature, the tooth movement plan breaks the treatment into a series of stages, including at least an initial stage. The number of stages depends on the complexity of the realignment from the initial teeth configuration to the final teeth configuration. A series of composite archwires used in treating orthodontic cases, especially moderate to complex orthodontic cases can be made prior to start of treatment with a custom form, one for each stage. The designed archwires can then be manufactured and delivered, allowing the clinician to use the archwires to move teeth without a need to make bends to change the shape of the wires. The custom composite archwire used at the initial stage has at least one multidimensional bend. The multidimensional bends account for and at least partially avoid high stress engagement with the brackets. The appropriate archwire engages the brackets, biasing the teeth towards predetermined end position for the stage while also allowing the teeth to move without major restrictions to sliding of archwire by avoiding sharp bends at bracket edges. The corrective force applied on each tooth is preferably a constant force irrespective of the amount of relative malocclusion between two teeth. Use of the method disclosed herein advantageously results in the formation of a series of customized archwires that provide continuous light forces while also reducing the treatment inefficiencies caused by binding of the wire against the bracket edges for the individual patient at each stage of the treatment. The wire becomes passive when the treatment objective is achieved for the particular stage of treatment.

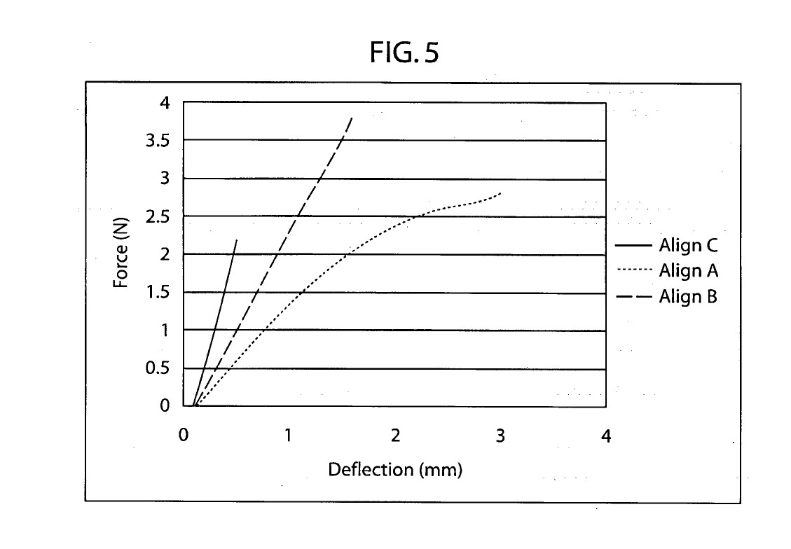

A number of stages, n can be selected, and can comprise at least two stages. For example: an initial stage where the initial teeth profile is established, followed by a first series of stages consisting of aligning and leveling of the teeth, followed by a second series of stages for correction of molar relationship and space closure. Optionally, a third series of stages for finishing may also be used. In accordance with a highly advantageous feature, an archwire is used at each stage, and the archwire has a custom form designed to apply sufficient corrective force to move a tooth no more than 3 mm per stage. With some materials, the amount of tooth movement may be limited to 1.5 mm per stage, or no more than 0.6 mm per stage, as required thereby maintaining light continuous forces on individual teeth irrespective of the wire type. See, for example, FIG. 5, which shows a force vs. deflection graph of several composite archwires. Typically when the archwire is first applied, the load or corrective force on the tooth is at a maximum, and the corrective force steadily diminishes as the tooth moves toward the end point for the particular stage.

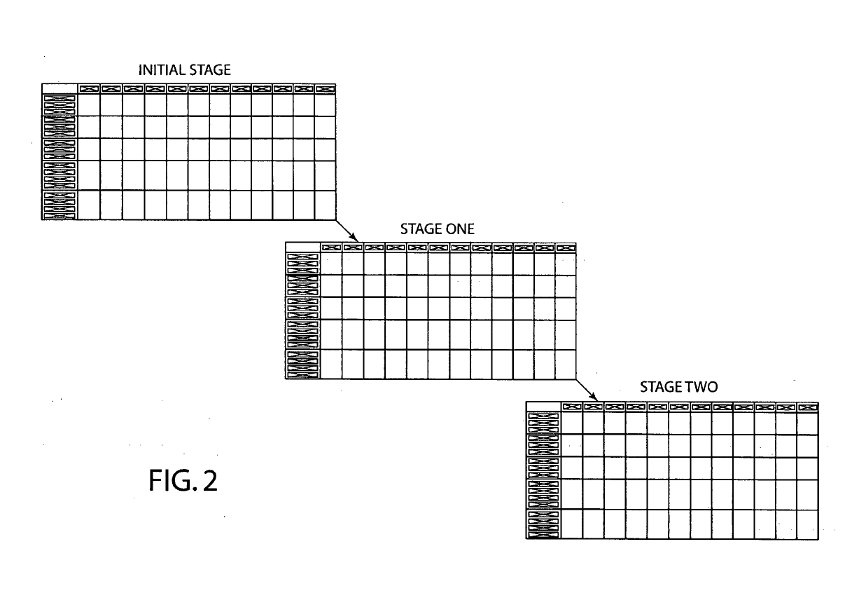

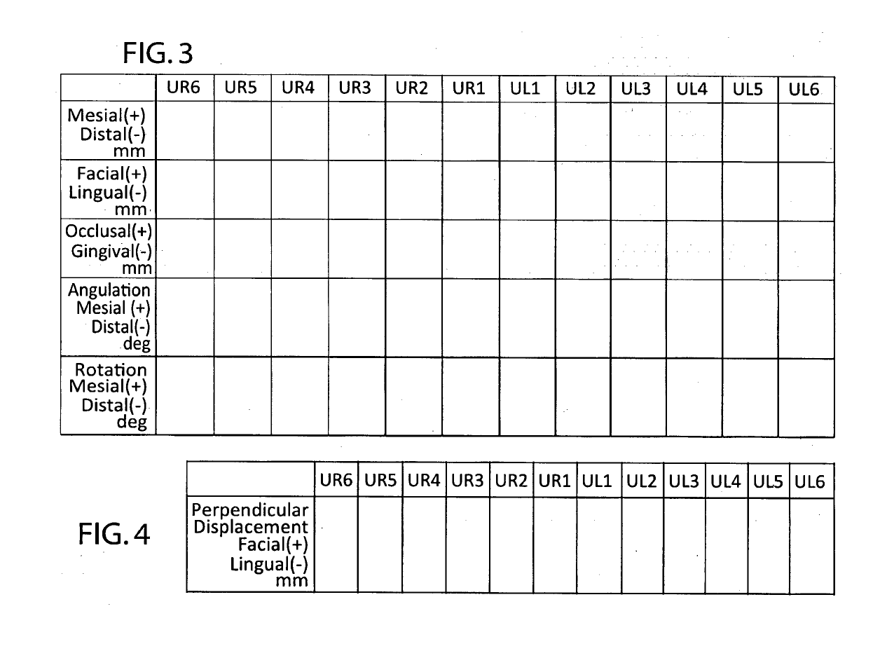

FIG. 2 shows the use of a series of tables which hold data corresponding to the initial stage, stage one and stage two. The tables can be used to define movement of teeth with respect to a reference location. For example, in the example shown in FIG. 3 an initial table define the position of each tooth with respect to a reference point. The initial table defines five coordinates for each tooth: three positions with respect to the reference point: mesial or distal (towards the front of the mouth or towards the back of the mouth), facial or lingual (towards the cheeks or towards the tongue), and occlusal or gingival (away from the gums or toward the root of the teeth); and two angles: angulation of the tooth (does the tooth pivot toward the front of the mouth or toward the back) and rotation (does the tooth pivot with respect to the row of teeth). Given the limitation of the amount of movement of the tooth at each stage, and knowing the amount of total tooth movement between the initial teeth configuration and a final teeth configuration, the number of stages and therefore the resulting number of tables can be determined. The initial teeth configuration, bracket mounting location for each tooth, including bracket angle, tooth movement plan, stages and each table may be stored on any kind of computer, laptop, hand held device, etc., for ease of access, and may be updated. For example, if the tooth movement plan is not implemented properly, the tooth movement plan may be updated and modified.

At each stage, after the custom formed archwire has moved the tooth or teeth, the custom formed archwire may be removed. A new stage begins with a new archwire attached to the brackets for further moving of the tooth or the teeth away from the initial teeth configuration and toward the desired teeth configuration. When the desired configuration is reached as indicated by the first table, a series of preformed archwires of standard commercially available archforms are used to attain the final desired configuration. As with the other archwires, the amount of corrective force applied to the teeth is limited by the distance the tooth is to be moved. This process of removing the old archwire and connecting the brackets with a new archwire is repeated for each stage, as required.

In certain cases, there may be a need for final wire refinement. This can be, for example, due to errors in bracket placement. A final custom archwire can be designed to compensate for these errors. To design the final wire, the orthodontist has to submit information on the final refinement needed. One or a series of custom archwires would be attached to the brackets for completing the series of stages. This final refinement step may make use of a second set of tables. FIG. 4 shows the second table. The second table is differentiated from the first table as the first table can be related to stages one and two of orthodontic treatment, while this second table is related to stage three—final wire refinement. Also, the second table may show relative movement of a tooth with respect to the final teeth configuration. The switch between the use of the first tables and the second tables may occur when the teeth reaches a predetermined position. For example, the switch to the second table may occur when the desired alignment and leveling of the first stage has been accomplished, i.e., when the tooth reaches a “zero position” or it may happen when the space closure or arch expansion is achieved. The switch will occur only after the stage where a preformed archwire can also be used for treatment using low forces

Once the dimensions of the archwire and the brackets, along with the bracket mounting locations has been determined, implementation of the advantageous method disclosed herein can occur. Brackets are attached to corresponding teeth at the bracket mounting location on the teeth preferably using an indirect bonding tray to reduce the incidence of errors that occur during direct manual bracket placement, and the archwire with the preselected custom form subject to the limitations of tooth displacement disclosed herein can be attached to the brackets, thereby applying the requisite corrective force to each tooth. After each stage, i.e., after each tooth has moved and stabilized, the old archwire is removed, and a new archwire is attached to the teeth. The process is repeated until the teeth are moved to the final teeth configuration and stabilized. A retainer may also be used to help with stability of the teeth.

From the foregoing disclosure and detailed description of certain embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A method for design of a series of custom composite orthodontic wires formed to be used in combination with brackets comprising, in combination, the steps of:
collecting data about an initial teeth configuration of a patient; and
generating a tooth movement plan, wherein the tooth movement plan comprises
determining both a bracket mounting location for each bracket on a corresponding tooth and a number of stages, including an initial stage,
determining movement of teeth from the initial teeth configuration to a final teeth configuration, and
determining the custom composite orthodontic wire for each stage of the number of stages;
wherein the custom composite orthodontic wire used at the initial stage has at least one multidimensional bend.

2. The method of claim 1 wherein the series of stages comprises at least two stages.

3. The method of claim 1 wherein the step of collecting data about the initial teeth configuration of the patient comprises measuring a position of the teeth with respect to a reference location.

4. The method of claim 1 wherein the wire is translucent and the brackets are translucent.

5. The method of claim 1 wherein each bracket has a bracket slot and the bracket mounting location comprises a position on the tooth and an angle on the tooth.

6. The method of claim 5 further comprising a bracket slot on each bracket, wherein the archwire is routed through the bracket slots to captivate the wire to the brackets.

7. The method of claim 1 wherein at least one of the series of stages is presentable in the form of a first table showing relative movement of all of the teeth connected by the wire with respect to the initial teeth configuration.

8. The method of claim 7 wherein at least one of the series of stages is presentable in the form of a second table showing relative movement of all of the teeth connected by the archwire biasing towards the final teeth configuration.

9. The method of claim 8 wherein a switch is made from one of the first tables to one of the second tables for a given tooth when a particular tooth reaches a predetermined position.

10. The method of claim 1 wherein each custom composite archwire is designed to move a tooth no more than 3 mm per stage when the archwire is attached to the brackets.

11. The method of claim 1 wherein each custom composite orthodontic wire is designed to move a tooth no more than 1.5 mm per stage when the archwire is attached to the brackets.

12. The method of claim 1 wherein each custom composite orthodontic wire is designed to move a tooth no more than 0.6 mm per stage when the archwire is attached to the brackets.

13. A method for moving teeth using a custom orthodontic appliance from an initial teeth configuration to a final teeth configuration by a tooth movement plan comprising a number of stages including an initial stage, the method comprising, in combination, the steps of:
attaching brackets at a bracket mounting location for each bracket on a corresponding tooth; and
connecting the brackets with a custom composite orthodontic wire for each stage;
wherein the custom composite orthodontic wire used at the initial stage has at least one multidimensional bend.

14. The method of claim 13 further comprising the steps of:
removing the wire after the tooth has moved after the initial stage;
beginning another stage by connecting the brackets with an additional custom composite orthodontic wire designed to apply sufficient corrective force to move a tooth; and
repeating the previous two steps for each stage in the series of stages.

15. The method of claim 13 wherein each custom composite orthodontic wire is designed to move a tooth no more than 3 mm per stage.

16. The method of claim 13 wherein the wire is translucent and the brackets are translucent.

17. The method of claim 13 wherein each custom composite orthodontic wire is designed to move a tooth no more than one of 1.5 mm per stage and 0.6 mm per stage.

18. The method of claim 1 wherein the mounting brackets are applied to the labial sides of the teeth.

19. The method of claim 13 wherein the mounting brackets are applied to the labial sides of the teeth.
